(19) United States
(12) Patent Application Publication
(10) Pub. No.: US 2019/0161010 A1
(43) Pub. Date: May 30, 2019

(54) HIGH VISIBILITY HEAD UP DISPLAY (HUD)

(71) Applicant: Panasonic Automotive Systems Company of America, Division of Panasonic Corporation of North America, Peachtree City, GA (US)

(72) Inventors: ROHAN REPALE, FARMINGTON HILLS, MI (US); EDO OMANOVIC, LIVONIA, MI (US)

(73) Assignee: Panasonic Automotive Systems Company of America, Division of Panasonic Corporation of North America

(21) Appl. No.: 16/182,881

(22) Filed: Nov. 7, 2018

Related U.S. Application Data
(60) Provisional application No. 62/592,870, filed on Nov. 30, 2017.

(51) Int. Cl. B60R 1/00; H04N 5/262; H04N 7/18; H04N 5/232; G02B 27/01

(52) U.S. Cl. CPC B60R 1/00; H04N 5/262; H04N 7/183; H04N 5/23229; G02B 27/0101; G02B 2027/0141; B60R 2300/30; B60R 2300/8053; G02B 2027/0138; G02B 2027/014; G02B 2027/0147; B60R 2300/205

(57) ABSTRACT

A display arrangement for a motor vehicle includes a camera capturing images of a scene in front of the motor vehicle. The camera transmits first video signals indicative of the captured images. A video processor is communicatively coupled to the camera and receives the first video signals. The video processor processes the first video signals to make objects in the first video signals easier to see, thereby producing second video signals. The video processor transmits the second video signals. A head up display system is communicatively coupled to the video processor and receives the second video signals. The head up display system reflects a light field off of a windshield of the motor vehicle such that the reflection is visible to a driver of the vehicle as a virtual image. The light field is dependent upon the second video signals.

### CROSS-REFERENCED TO RELATED APPLICATIONS

This application claims benefit of U.S. Provisional Application No. 62/592,870 filed on Nov. 30, 2017, which the disclosure of which is hereby incorporated by reference in its entirety for all purposes.

### FIELD OF THE INVENTION

The disclosure relates to a head up display (HUD) system in a motor vehicle.

### BACKGROUND OF THE INVENTION

A head up display system emits light that reflects from the front windshield to be seen by the driver. The light appears to come from a virtual image in front of the driver and in front of the windshield.

Conventional head up displays create the virtual image by first using a display to create an image. Next, the light from the image is reflected from one or more mirrors, and then the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

### SUMMARY

The present invention may provide video feed processing for snow/fog removal in a motor vehicle. More particularly, the invention may provide a feature that enables a head up display (HUD) to show elements of the road ahead even when there is poor visibility. The elements of the road can be lane markers, other vehicles, obstacles, pedestrian, guardrails, etc. This feature can be turned on during foggy/rainy/low visibility days, and may be turned off when not needed.

The video signal from a front view camera can provide images of the elements of the road. Generally, the same camera that is currently included in high end vehicles can be used as this front view camera. Image processing may extract the needed information (e.g., the elements of the road) from the video feed. This signal can then be projected to the driver using HUD.

The front view camera video feed may be used and displayed such that video feed processing may remove snow/fog for a clearer view of the road. Lanes and guardrails can be highlighted or visually enhanced on the HUD, thus highlighting the path ahead for the driver. Obstacles on the road ahead may be highlighted or visually enhanced on the HUD and outlined. The distance to an obstacle may be indicated by the color with which the obstacle is highlighted or visually enhanced. For example, yellow may indicate that the obstacle is relatively far away, while red may indicate that the obstacle is relatively close.

During had weather, excessive rain, snow or fog/smog can lead to poor visibility and hazardous driving conditions, and the present invention may improve visibility and safety. A snow removal feature may utilize heavy image processing and project a very bright image on the windshield, which may enable the driver to see ahead more clearly.

In one embodiment, the invention comprises a display arrangement for a motor vehicle, including a camera capturing images of a scene in front of the motor vehicle. The camera transmits first video signals indicative of the captured images. A video processor is communicatively coupled to the camera and receives the first video signals. The video processor processes the first video signals to make objects in the first video signals easier to see, thereby producing second video signals. The video processor transmits the second video signals. A head up display system is communicatively coupled to the video processor and receives the second video signals. The head up display system reflects a light field off of a windshield of the motor vehicle such that the reflection is visible to a driver of the vehicle as a virtual image. The light field is dependent upon the second video signals.

In another embodiment, the invention comprises a display method for a motor vehicle, including capturing first images of a scene in front of the motor vehicle. The first images are processed to make objects in the first images easier to see, thereby producing second images. A light field is reflected off of a windshield of the motor vehicle such that the reflection is visible to a driver of the vehicle as a virtual image. The light field is dependent upon the second images.

In yet another embodiment, the invention comprises a head up display arrangement for a motor vehicle. The arrangement includes a camera capturing images of a scene in front of the motor vehicle, and transmitting first video signals indicative of the captured images. A switch device may be selectively turned ON or turned OFF by a driver of the motor vehicle. A video processor is communicatively coupled to the camera and to the switch device. The video processor receives the first video signals, and, if the switch is turned ON, processes the first video signals to make objects in the first video signals easier to see, thereby producing second video signals. The video processor then transmits the second video signals. A head up display system is communicatively coupled to the video processor and receives the second video signals. The head up display system reflects a light field off of a windshield of the motor vehicle such that the reflection is visible to a driver of the vehicle as a virtual image. The light field is dependent upon the second video signals.

An advantage of the present invention is that it provides driving aid during poor visibility driving conditions, thus saving lives and infrastructure. When visibility becomes very poor, the driver may turn on the inventive feature. The inventive feature may enable the driver to be sure that they are in their lane and see vehicles up ahead which otherwise would not be visible.

### BRIEF DESCRIPTION OF THE DRAWINGS

A better understanding of the present invention will be had upon reference to the following description in conjunction with the accompanying drawings.

FIG. 1 is a block diagram of one embodiment of a high visibility head up display arrangement of the present invention.

FIG. 2a is a driver's view of a road in fog with the arrangement of FIG. 1 turned off.

FIG. 2b is a driver's view of a road in fog with the arrangement of FIG. 1 turned on.

FIG. 3a is a driver's view of a road in snow with the arrangement of FIG. 1 turned off.

FIG. 3b is a driver's view of a road in snow with the arrangement of FIG. 1 turned on.

FIG. 4 is a flow chart of one embodiment of a display method of the present invention for a motor vehicle.

### DETAILED DESCRIPTION OF THE PREFERRED EMBODIMENTS

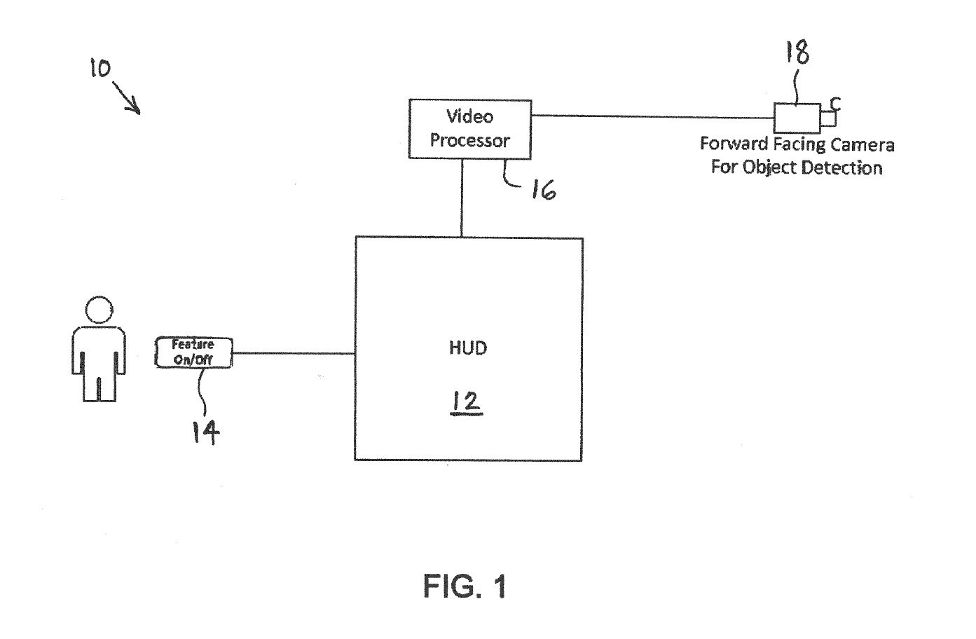

FIG. 1 illustrates one example embodiment of a high visibility head up display HUD arrangement 10 of the present invention, including a head up display system 12 connected to an on/off switch 14 and a video processor 16. Video processor 16 is further connected to a forward-facing camera 18 for object detection.

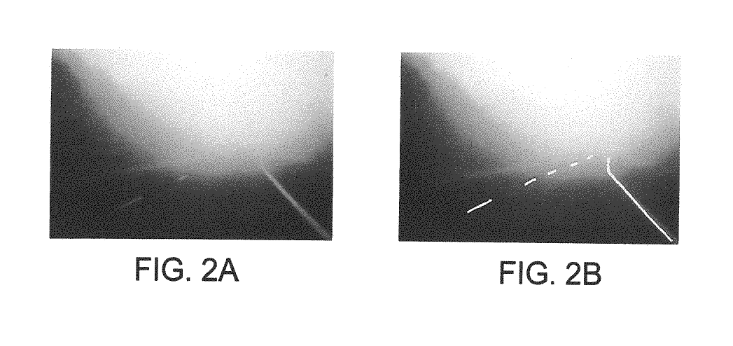

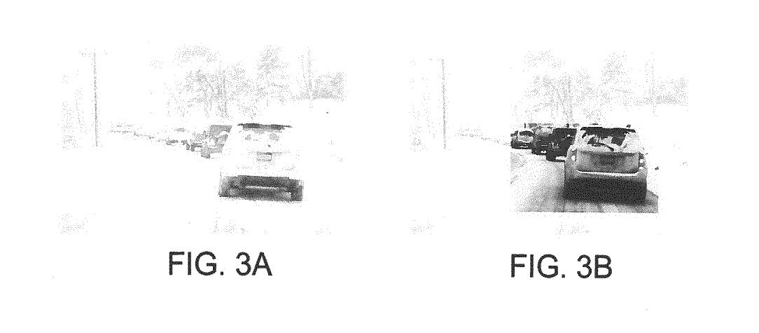

During use, forward facing camera 18 may capture images of a scene of the road in front of the vehicle. If the driver has switch 14 turned on, then video processor 16 may appropriately process the images captured by camera 18 for presentation to the driver on HUD system 12. For example, if video processor 16 determines that the images captured by camera 18 include fog, as shown in FIG. 2a, then video processor 16 may process the images to highlight or enhance the lane markers on the road, as shown in FIG. 2b. As another example, if video processor 16 determines that the images captured by camera 18 include snow or a high degree of glare, as shown in FIG. 3a, then video processor 16 may process the images to reduce the glare, as shown in FIG. 3b.

It is to be understood that on/off switch 14 may include any means by which the user may turn on or turn off the inventive feature. Switch 14 may be in the form of a toggle switch, a button on a touch-sensitive screen, or software that responds to a voice command via a microphone, for example.

The invention may also be applied to an augmented reality HUD system.

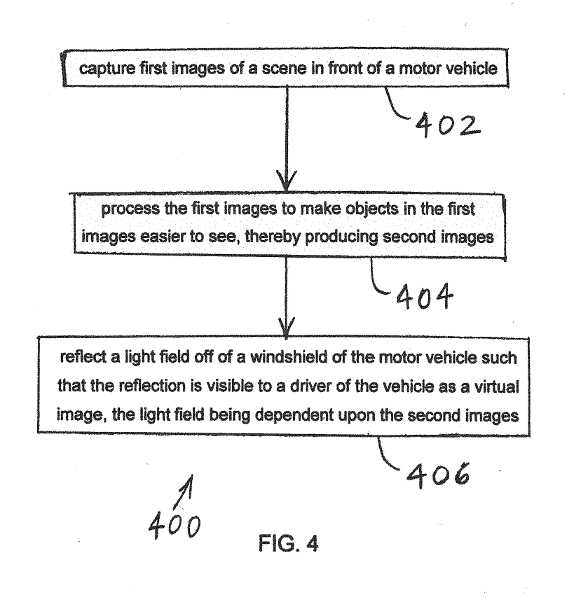

FIG. 4 illustrates one embodiment of a display method 400 of the present invention for a motor vehicle. In a first step 402, first images of a scene in front of the motor vehicle are captured. For example, forward facing camera 18 may capture images of a scene of the road in front of the vehicle.

In a next step 404, the first images are processed to make objects in the first images easier to see, thereby producing second images. For example, if video processor 16 determines that the images captured by camera 18 include fog, as shown in FIG. 2a, then video processor 16 may process the images to highlight or enhance the lane markers on the road, as shown in FIG. 2b. As another example, if video processor 16 determines that the images captured by camera 18 include snow or a high degree of glare, as shown in FIG. 3a, then video processor 16 may process the images to reduce the glare, as shown in FIG. 3b.

In a final step 406, a light field is reflected off of a windshield of the motor vehicle such that the reflection is visible to a driver of the vehicle as a virtual image. The light field is dependent upon the second images. For example, video processor 16 may transmit the processed images to head up display system 12. System 12 may project a light field that is based on the processed images, and that is reflected off an inside surface of a windshield of the motor vehicle wherein the reflection is visible to a driver of the vehicle as a virtual image.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A display arrangement for a motor vehicle, the arrangement comprising:
a camera configured to:
capture images of a scene in front of the motor vehicle; and
transmit first video signals indicative of the captured images;
a video processor communicatively coupled to the camera and configured to:
receive the first video signals;
process the first video signals to make objects in the first video signals easier to see, thereby producing second video signals; and
transmit the second video signals; and
a head up display system communicatively coupled to the video processor and configured to:
receive the second video signals; and
reflect a light field off of a windshield of the motor vehicle such that the reflection is visible to a driver of the vehicle as a virtual image, the light field being dependent upon the second video signals.

2. The display arrangement of claim 1 wherein the video processor is configured to:
determine whether the objects in the first video signals would be difficult for a driver to see through a windshield of the vehicle; and
if the video processor determines that the objects in the first video signals would be difficult for a driver to see through a windshield of the vehicle, then process the first video signals to make the objects in the first video signals easier to see, thereby producing the second video signals.

3. The display arrangement of claim 1 wherein the video processor is configured to enhance or highlight lane markings on a road in the first video signals to make the lane markings in the first video signals easier to see, thereby producing the second video signals.

4. The display arrangement of claim 1 wherein the video processor is configured to reduce glare in the first video signals, thereby producing the second video signals.

5. The display arrangement of claim 1 wherein the video processor is configured to enhance or highlight guardrails next to a road in the first video signals to make the guardrails in the first video signals easier to see, thereby producing the second video signals.

6. The display arrangement of claim 1 wherein the video processor is configured to enhance or highlight an obstacle in a road in the first video signals, thereby producing the second video signals.

7. The display arrangement of claim 6 wherein the video processor is configured to enhance or highlight the obstacle with a first color if the obstacle is less than a threshold distance away from the motor vehicle, and enhance or highlight the obstacle with a second color if the obstacle is more than the threshold distance away from the motor vehicle.

8. A display method for a motor vehicle, the method comprising:
capturing first images of a scene in front of the motor vehicle;
processing the first images to make objects in the first images easier to see, thereby producing second images; and
reflecting a light field off of a windshield of the motor vehicle such that the reflection is visible to a driver of the vehicle as a virtual image, the light field being dependent upon the second images.

9. The display method of claim 8 further comprising;
determining whether the objects in the first video signals would be difficult for a driver to see through a windshield of the vehicle; and
if it is determined that the objects in the first video signals would be difficult for a driver to see through a windshield of the vehicle, then processing the first video signals to make the objects in the first video signals easier to see, thereby producing the second video signals.

10. The display method of claim 8 wherein the processing includes enhancing or highlighting lane markings on a road in the first video signals to make the lane markings in the first video signals easier to see, thereby producing the second video signals.

11. The display method of claim 8 wherein the processing includes reducing glare in the first video signals, thereby producing the second video signals.

12. The display method of claim 8 wherein the processing includes enhancing or highlighting guardrails next to a road in the first video signals to make the guardrails in the first video signals easier to see, thereby producing the second video signals.

13. The display method of claim 8 wherein the processing includes enhancing or highlighting an obstacle in a road in the first video signals, thereby producing the second video signals.

14. The display method of claim 13 wherein the processing includes enhancing or highlighting the obstacle with a first color if the obstacle is less than a threshold distance away from the motor vehicle, and enhancing or highlighting the obstacle with a second color if the obstacle is more than the threshold distance away from the motor vehicle.

15. A display arrangement for a motor vehicle, the arrangement comprising;
a camera configured to:
capture images of a scene in front of the motor vehicle; and
transmit first video signals indicative of the captured images;
a switch device configured to be turned ON or turned OFF by a driver of the motor vehicle;
a video processor communicatively coupled to the camera and to the switch device, the video processor being configured to:
receive the first video signals;
if the switch is turned ON, process the first video signals to make objects in the first video signals easier to see, thereby producing second video signals; and
transmit the second video signals; and
a head up display system communicatively coupled to the video processor and configured to:
receive the second video signals; and
reflect a light field off of a windshield of the motor vehicle such that the reflection is visible to a driver of the vehicle as a virtual image, the light field being dependent upon the second video signals.

16. The display arrangement of claim 15 wherein, if the switch is turned OFF, the light field is dependent upon the first video signals and is independent of the second video signals.

17. The display arrangement of claim 15 wherein, if the switch is turned ON, the video processor is configured to enhance or highlight lane markings on a road in the first video signals to make the lane markings in the first video signals easier to see, thereby producing the second video signals.

18. The display arrangement of claim 15 wherein, if the switch is turned ON, the video processor is configured to reduce glare in the first video signals, thereby producing the second video signals.

19. The display arrangement of claim 15 wherein, if the switch is turned ON, the video processor is configured to enhance or highlight guardrails next to a road in the first video signals to make the guardrails in the first video signals easier to see, thereby producing the second video signals.

20. The display arrangement of claim 15 wherein, if the switch is turned ON, the video processor is configured to enhance or highlight an obstacle in a road in the first video signals, thereby producing the second video signals.

21. The display arrangement of claim 20 wherein, if the switch is turned ON, the video processor is configured to enhance or highlight the obstacle with a first color if the obstacle is less than a threshold distance away from the motor vehicle, and enhance or highlight the obstacle with a second color if the obstacle is more than the threshold distance away from the motor vehicle.
